(19) United States
(12) Patent Application Publication
(10) Pub. No.: US 2026/0316460 A1
(43) Pub. Date: Oct. 15, 2026

(54) IMAGE FORMING APPARATUS, ICC PROFILE CREATION METHOD, AND STORAGE MEDIUM

(71) Applicant: Konica Minolta, Inc., Tokyo (JP)

(72) Inventor: Shinya Miyazawa, Tokyo (JP)

(73) Assignee: Konica Minolta, Inc., Tokyo (JP)

(21) Appl. No.: 19/646,552

(22) Filed: Apr. 13, 2026

(30) Foreign Application Priority Data
Apr. 14, 2025 (JP) 2025-066262

(51) Int. Cl. B41J 2/21; H04N 1/60

(52) U.S. Cl. CPC B41J 2/2135; H04N 1/6033

(57) ABSTRACT

An image forming apparatus includes: a sheet feeder configured to accommodate a recording medium; an image former configured to form an image on the recording medium; a color measurer configured to measure a color of the image formed on the recording medium; and a hardware processor configured to execute an automatic creation process for automatically creating an ICC profile corresponding to the recording medium for which the ICC profile is not set.

### CROSS-REFERENCE TO RELATED APPLICATION

The entire disclosure of Japanese Patent Application No. 2025-066262, filed on Apr. 14, 2025, including description, claims, drawings and abstract is incorporated herein by reference.

### BACKGROUND OF THE INVENTION

### Technical Field

The present disclosure relates to an image forming apparatus, an ICC profile creation method, and a storage medium.

### Description of Related Art

Conventionally, in an image forming apparatus, to form an image having a desired color, an ICC (International Color Consortium) profile is set for a recording medium by performing color measurement, with a colorimeter, on a chart formed on the recording medium.

For example, Japanese Unexamined Patent Application Publication No. 2010-252053 describes a configuration in which color gamut characteristics such as lightness and chroma are calculated by performing color measurement, using an offline measuring device, of color values of a chart printed on a recording medium, and a similar ICC profile is selected from among ICC profiles prepared in advance and is set.

However, in the invention disclosed in Japanese Unexamined Patent Application Publication No. 2010-252053, color information of printed material is acquired using an offline measuring device. Accordingly, manual color measurement is required, however, because the chart typically includes several hundred to several thousand patch images, it is time-consuming and labor-intensive.

### SUMMARY OF THE INVENTION

The present disclosure has been made in view of such circumstances. An object of the present disclosure is to provide an image forming apparatus, an ICC profile creation method, and a storage medium that enable an ICC profile suitable for a recording medium to be more easily set.

According to one aspect of the present disclosure, an image forming apparatus reflecting one aspect of the present disclosure includes,
a sheet feeder configured to accommodate a recording medium;
an image former configured to form an image on the recording medium;
a color measurer configured to measure a color of the image formed on the recording medium; and
a hardware processor configured to execute an automatic creation process for automatically creating an ICC profile corresponding to the recording medium for which the ICC profile is not set.

According to another aspect of the present disclosure, an ICC profile creation method for creating an ICC profile by an image forming apparatus including, a sheet feeder configured to accommodate a recording medium; an image former configured to form an image on the recording medium; and a color measurer configured to measure a color of the image formed on the recording medium, the method including:
executing an automatic creation process for automatically creating the ICC profile corresponding to the recording medium for which the ICC profile is not set.

According to another aspect of the present disclosure, a non-transitory computer readable storage medium including a program executed in a computer of an image forming apparatus including, a sheet feeder configured to accommodate a recording medium; an image former configured to form an image on the recording medium; and a color measurer configured to measure a color of the image formed on the recording medium, the program causing the computer to perform,
executing an automatic creation process for automatically creating the ICC profile corresponding to the recording medium for which the ICC profile is not set.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a side cross-sectional view of an image forming apparatus;

FIG. 2 is a block diagram of the image forming apparatus;

FIG. 3 is a diagram showing an example of a management table;

FIG. 4 is a flowchart of an ICC profile creation process according to a first embodiment;

FIG. 5 is an example of a timeline chart of an image forming apparatus;

FIG. 6 is an example of a timeline chart of the image forming apparatus; and

FIG. 7 is a flowchart of an ICC profile creation process according to a second embodiment.

### DETAILED DESCRIPTION

Hereinafter, one or more embodiments of the present disclosure will be described with reference to the drawings. However, the scope of the invention is not limited to the disclosed embodiments.

The following description describes one or more embodiments of the present disclosure with reference to the drawings. The advantages and features of embodiments of the present disclosure will be understood from the following detailed description and the drawings. The following detailed description and drawings are provided for illustrative purposes only and do not limit the scope of the present disclosure.

### First Embodiment

### Overall Configuration of Image Forming Apparatus

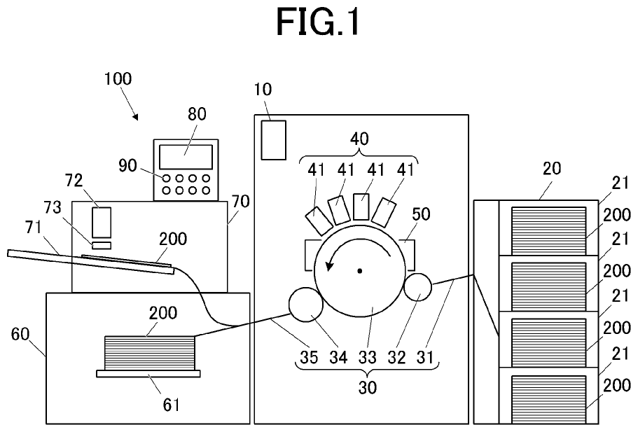

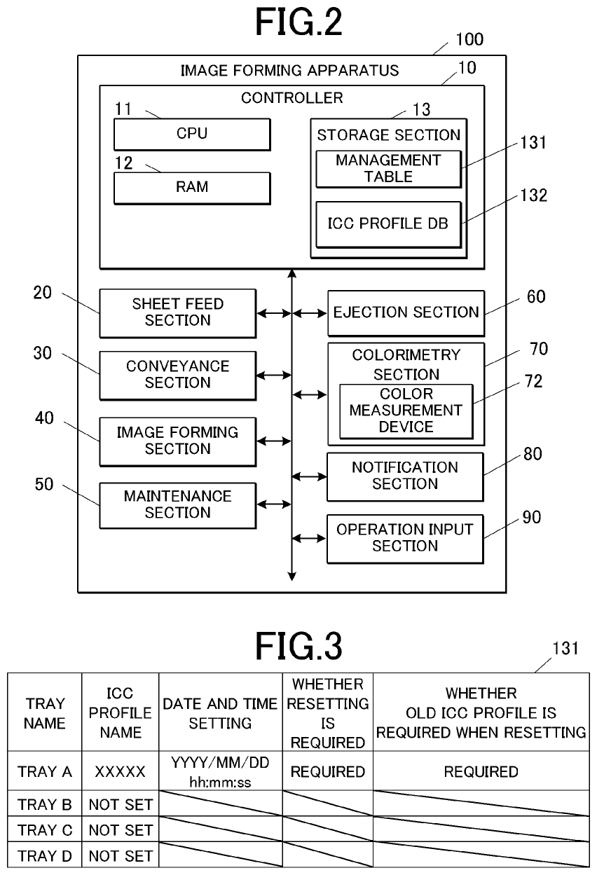

FIG. 1 is a diagram illustrating a schematic configuration of an image forming apparatus 100 according to a first embodiment. FIG. 2 is a block diagram illustrating a functional configuration of an image forming apparatus 100 according to the first embodiment. In the following, the description proceeds on the assumption that an image forming section 40, which will be described later, includes a plurality of inkjet heads, and that the image forming apparatus 100 is an inkjet recording apparatus that forms an image on a recording medium 200 by an inkjet method. However, the image forming apparatus 100 is not limited to an inkjet recording apparatus, and may be, for example, a laser printer or the like that forms an image by an electrophotographic method.

As illustrated in FIGS. 1 and 2, the image forming apparatus 100 includes a controller 10 (a hardware processor), a sheet feed section (sheet feeder) 20, a conveyance section 30, an image forming section (image former) 40, a maintenance section 50, an ejection section 60, a colorimetry section 70, a notification section 80, and an operation input section 90. The units of the image forming apparatus 100 are connected via a bus.

### Sheet Feed Section

The sheet feed section 20 includes, for example, a sheet feed tray 21 configured to store a recording medium 200, and stores the recording medium 200 in the sheet feed tray 21. As described above, various media may be used as the recording medium 200. Accordingly, as shown in FIG. 1, the sheet feed section 20 may include a plurality of sheet feed trays 21 that respectively store various types of recording medium 200.

### Recording Medium

As the recording medium 200, various media capable of fixing ink deposited on a surface thereof may be used. Examples of the recording medium 200 include paper, textile, sheet-like resin, and the like. When the recording medium 200 is paper, examples thereof include plain paper and coated paper. In particular, the recording medium 200 is preferably cut-sheet paper.

It should be noted that the “different types of recording medium” in the present disclosure are not limited to cases where the properties of the recording medium 200 differ, such as plain paper and coated paper. For example, the “different types of recording medium” also include a case in which both are plain paper but differ in size, thickness, or the like.

### Conveyance Section

The conveyance section 30 conveys the recording medium 200 in a conveyance direction. As shown in FIG. 1, the conveyance section 30 includes, for example, a feeder board 31, a first handover drum 32, a conveyance drum 33, a second handover drum 34, and a carry-out section 35.

### Feeder Board, First Handover Drum

The feeder board 31 transports the recording medium 200 from the sheet feed section 20 to the first handover drum 32. The first handover drum 32 holds and picks up one end of the recording medium 200 conveyed by the feeder board 31, and delivers the recording medium 200 to the conveyance drum 33.

### Conveyance Drum

The conveyance drum 33 has a cylindrical shape. An outer circumferential surface of the conveyance drum 33 serves as a conveyance surface that suction-holds the recording medium 200. With the recording medium 200 held on the conveyance surface, the conveyance drum 33 rotates in the conveyance direction about a central axis (as a rotation axis) extending in a width direction orthogonal to the conveyance direction. Accordingly, the conveyance drum 33 conveys, along the conveyance surface, the recording medium 200 that is suction-held on the conveyance surface.

### Second Handover Drum

The second handover drum 34 holds one end of the recording medium 200 conveyed by the conveyance drum 33, picks up the recording medium 200, and hands over the recording medium 200 to the carry-out section 35.

### Carry-Out Section

The carry-out section 35 defines a carry-out path for the recording medium 200 and conveys the recording medium 200 to the ejection section 60, the colorimetry section 70, or the like. The carry-out section 35 includes, for example, a belt, a roller, or the like. When the image forming apparatus 100 includes the ejection section 60 and the colorimetry section 70, the carry-out path in the carry-out section 35 may branch midway, as illustrated in FIG. 1.

### Image Forming Section

The image forming section 40 forms the image on the recording medium 200 based on image data acquired from the controller 10. The image forming section 40 includes one or a plurality of head units 41 arranged in the width direction and having a length (width) that covers an entire width of the recording medium 200. That is, the image forming apparatus 100 according to the present embodiment is a one-pass (single-pass, line-head) inkjet recording apparatus.

### Head Unit

Each head unit 41 includes one or a plurality of inkjet heads. The head unit 41 includes an ink ejection face at a position facing the conveyance surface of the conveyance drum 33. The head unit 41 ejects ink onto the recording medium 200 held by the conveyance drum 33 at an appropriate timing in accordance with rotation of the conveyance drum 33, thereby forming the image.

In the image forming apparatus 100 illustrated in FIG. 1, the four head units 41 are arranged at predetermined intervals in order from an upstream side in a rotation direction of the conveyance drum 33. The four head units 41 respectively eject inks of four colors, for example, yellow (Y), magenta (M), cyan (C), and black (K).

In the image forming section 40, a normal job and a color measurement job, among others, are performed. The normal job is a print job in which, based on a print job acquired from an external device (not illustrated) or the like, a normal image that is not a color measurement target of a color measurement device (color measurer) 72 described later is formed on the recording medium 200. The color measurement job is a print job for forming, on the recording medium 200, a chart to be subjected to color measurement by the color measurement device 72.

The chart is composed of, for example, a plurality of patch images having different tone values, such as primary colors (C, M, Y, and K) and secondary colors (mixtures of the primary colors), and is used by the color measurement device 72 to create an ICC profile.

The image forming section 40 may further include a reading device that irradiates the recording medium 200 with light from a light source and reads a reflected image, a fixing section that fixes the ink ejected onto the recording medium 200 by the head unit 41, and the like.

### Maintenance Section

The maintenance section 50 performs, as a maintenance process, for example, cleaning of the head unit 41. For example, the maintenance section 50 is provided on a width direction side of the conveyance drum 33, and cleans the head unit 41 that has moved in the width direction.

Examples of the cleaning include wiping to wipe off and remove the ink adhering to the ink ejection face of the head unit 41, purging to suppress, for example, occurrence of clogging by ejecting ink in an ink channel, and the like.

In FIG. 1, a configuration in which the maintenance section 50 is provided on only one side in the width direction of the conveyance drum 33 is illustrated; however, the present disclosure is not limited thereto. For example, the maintenance section 50 may be provided on both sides of the conveyance drum 33 in the width direction.

### Ejection Section

The recording medium 200 that has passed through the image forming section 40 is discharged to the ejection section 60. The ejection section 60 is provided separately from the colorimetry section 70. When the image forming apparatus 100 includes the ejection section 60 separately from the colorimetry section 70, for example, only the recording medium 200 on which the color measurement job has been performed is discharged to the colorimetry section 70, and the recording medium 200 on which the normal job has been performed is discharged to the ejection section 60. The ejection section 60 includes, for example, a discharge tray 61 that stores the recording medium 200.

### Colorimetry Section

As described above, the recording medium 200 on which the color measurement job has been performed is discharged, and the colorimetry section 70 performs a color measurement process (in-line color measurement) on the recording medium 200. The colorimetry section 70 includes a color measurement tray 71 that stores the discharged recording medium 200, a color measurement device 72 that performs the color measurement process, and a calibration plate 73 used to calibrate the color measurement device 72.

Specifically, in the colorimetry section 70, the color measurement device 72 performs a color measurement process on the recording medium 200 that is stopped on the color measurement tray 71 under control of the controller 10. The color measurement process is processing for measuring color information, and for example, the color measurement device 72 measures color values such as L*a*b* values. The color measurement device 72 creates the ICC profile used for color conversion based on the result of the color measurement process, and transmits the ICC profile to the controller 10. As the color measurement device 72, for example, a spectrophotometer that performs the color measurement by spectrally dispersing reflected light from the recording medium 200 may be used.

In a conventional printing apparatus in which a colorimeter is installed on a conveyance route of the recording medium 200, while waiting for a color value to stabilize for the color measurement, it may not be possible to perform subsequent operations such as the print job or maintenance, resulting in low printing efficiency. In addition, in a conventional image forming system in which the colorimeter is provided separately from the image forming apparatus 100, the user needs to manually operate the colorimeter to perform the color measurement, which is burdensome.

In contrast, in the image forming apparatus 100 of the present disclosure, the recording medium 200 discharged to the colorimetry section 70 is subjected to color measurement by the color measurement device 72. With this configuration, work such as the next print job, maintenance, or the like can be performed more readily even while waiting for color measurement and/or during color measurement, thereby enabling both the color measurement and efficient printing. In addition, because the image forming apparatus 100 includes the color measurement device 72, the controller 10 can readily control a printing process and the color measurement process, thereby reducing the user's burden. In addition, because the color measurement is performed on the recording medium 200 while the recording medium 200 is stopped, the accuracy of the color measurement is higher than in a case where the color measurement is performed on the recording medium 200 while the recording medium 200 is moving.

The “color measurement on the recording medium in a stopped state” in the present disclosure also includes the color measurement performed by repeating the color measurement on a part of the recording medium 200 in a stopped state and movement of the recording medium 200.

For example, first, while the color measurement device 72 scans in the width direction of the recording medium 200, the color measurement is performed on a first row in a conveyance direction of the recording medium 200, which is in the stopped state. At this time, one row of the recording medium 200 is, for example, a range in which the color measurement device 72 can perform the color measurement in a single scan. When the color measurement for the first row of the recording medium 200 is completed, the recording medium 200 moves by one row within the colorimetry section 70. Next, while the color measurement device 72 scans again in the width direction of the recording medium 200, the color measurement is performed on a second row adjacent to the first row in the conveyance direction of the recording medium 200 while the recording medium 200 is in the stopped state. When the color measurement for the second row of the recording medium 200 in the conveyance direction is completed, the recording medium 200 is again moved by one row within the colorimetry section 70.

As described above, the color measurement according to the present disclosure need not be performed at once on the recording medium 200 in the stopped state, and may be performed while the recording medium 200 is repeatedly stopped and moved.

In addition, the color value of the image on the recording medium 200 discharged to the colorimetry section 70 may not stabilize immediately, for example, because the ink has not yet dried. Therefore, the color measurement process is preferably performed after a predetermined color measurement waiting time has elapsed after the recording medium 200 has been discharged to the colorimetry section 70.

The color measurement waiting time may be adjusted in accordance with at least one of a sheet type, a sheet thickness, an ink type, an image density, and an ink amount regarding the recording medium 200. The ink amount may be a total ink amount for the entire recording medium 200, or may be a maximum ink amount per unit area of the recording medium 200. The color measurement waiting time may be adjusted in accordance with at least one of a sheet-surface temperature of the recording medium 200 during printing and the temperature and/or humidity of the colorimetry section 70. Adjustment of the color measurement waiting time may be performed by the user or may be performed based on control by the controller 10.

Further, the colorimetry section 70 calibrates the color measurement device 72 using the calibration plate 73 at a predetermined timing. The predetermined timing is, for example, a timing when the colorimetry section 70 is set up, or a timing when the recording medium 200 of a type different from that used up to then is used.

The calibration plate 73 is, for example, a white tile, and is used to calibrate the color measurement device 72. Specifically, a color measurement result (color measurement value) of the calibration plate 73 is obtained by the color measurement device 72, and a reading result obtained by the color measurement device 72 is corrected based on the color measurement value.

### Notification Section

The notification section 80 is, for example, a display, and provides notification of various types of information by displaying the information on a screen, for example. The notification section 80 is not limited to a display, and may be, for example, a speaker that outputs sound, a communication section that transmits information to an external device, or the like.

### Operation Input Section

The operation input section 90 receives various inputs related to operation of the image forming apparatus 100 in response to a user's operation. The operation input section 90 includes, for example, a touch screen type input/display device, up/down/left/right movement keys for operations such as data selection and feed, and various function keys. The operation input section 90 outputs, to the CPU of the controller 10, a key-press signal corresponding to a key pressed by the user and an operation signal corresponding to a mouse or the like. The operation input section 90 may be integrated with the notification section 80.

### Controller

The controller 10 controls operations of other functional components in accordance with print image data, print settings, and the like. The controller 10 is a computer and includes, for example, a central processing unit (CPU) 11, a random access memory (RAM) 12, and a storage section (storage) 13.

### Central Processing Unit (CPU), Random Access Memory (RAM)

The CPU 11 executes various control programs to control driving of the image forming apparatus 100, and performs various arithmetic processing operations. The RAM 12 provides a working memory space for the CPU 11 and stores temporary data. The RAM 12 may include a non-volatile memory.

### Storage Section

The storage section 13 stores programs to be executed by the CPU 11, various setting data, and the like. As the storage section 13, for example, a hard disk drive (HDD) is used, and a dynamic random access memory (DRAM) or the like may be used in combination therewith. The storage section 13 stores a management table 131 and an ICC profile DB 132.

### Management Table, ICC Profile DB

FIG. 3 shows an example of the management table 131. As shown in FIG. 3, the management table 131 stores, for each sheet feed tray 21 of the sheet feed section 20, a name of the ICC profile, a date and time when the ICC profile was set, whether a resetting process to be described below is required, and a setting as to whether the previous ICC profile is required when the resetting process is executed. The ICC profile DB 132 stores the ICC profiles created to date in a searchable manner in association with the set type of the recording medium 200.

The controller 10 functions as an acquisition section and a creation controller, in particular, by causing the CPU 11 to execute the program.

### Acquisition Section

The acquisition section receives content entered by the user via the operation input section 90. For example, when the user stores a new recording medium 200 in the sheet feed tray 21, the acquisition section acquires, from the user via the operation input section 90, an instruction indicating whether to execute automatic creation processing for automatically creating a corresponding ICC profile. Further, when the user stores a plurality of types of recording medium 200 in a plurality of sheet feed trays 21, respectively, the acquisition section acquires, from the user via the operation input section 90, an instruction indicating an execution order of the automatic creation processing. Details of the automatic creation processing will be described below.

The acquisition section is not limited to a configuration in which the acquisition section acquires content entered into the operation input section 90 included in the image forming apparatus 100, and may acquire content entered into an apparatus separate from the image forming apparatus 100, the apparatus including a configuration corresponding to the operation input section 90.

Also, the acquisition section acquires the print job from the external apparatus (not shown).

### Creation Controller

When the acquisition section acquires the instruction to execute the automatic creation processing, the creation controller controls the image forming section 40 and the colorimetry section 70 to execute the automatic creation processing.

### ICC Profile Setting Process

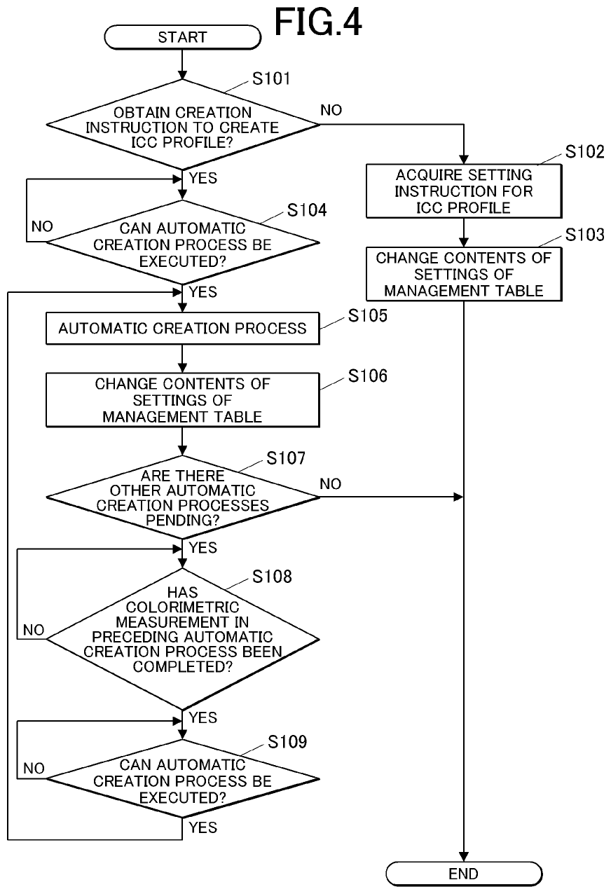

As described above, an ICC profile setting process, including automatic creation processing, performed by the image forming apparatus 100 according to the first embodiment will be described with reference to the flowchart of FIG. 4. The ICC profile setting process is performed to set the ICC profile corresponding to the recording medium 200, for example, when setting up the image forming apparatus 100 or when using the new recording medium 200.

First, the user sets the recording medium 200 in a predetermined sheet feed tray 21 of the sheet feed section 20. Then, the user inputs, via the operation input section 90, an indication that the recording medium 200 has been set in the predetermined sheet feed tray 21. The controller 10 determines, based on the input operation, whether the acquisition section has acquired a creation instruction to create the ICC profile corresponding to the recording medium 200 (step S101).

For example, when the recording medium 200 set in the sheet feed tray 21 is of the type that has been used before and the suitable ICC profile is prestored in the ICC profile DB 132, the ICC profile may be reused. As described above, when the acquisition section does not acquire the creation instruction (step S101; No) but acquires the setting instruction for the existing ICC profile (step S102), the controller 10 changes the settings in the management table 131 based on the acquired setting instruction (step S103).

Specifically, the controller 10 rewrites, in the management table 131, the record corresponding to the sheet feed tray 21 with the settings acquired in step S102. After the settings in the management table 131 are changed, the controller 10 ends the ICC profile setting process.

When the new recording medium 200 set in the sheet feed tray 21 is, for example, of a type that has not been used before, the user issues the creation instruction to create the ICC profile.

At this time, when different types of recording medium 200 are set in the plurality of sheet feed trays 21 and it is necessary to create the ICC profiles for the plurality of recording medium 200, the instruction indicating the execution order of the automatic creation processing may be accepted.

When the acquisition section acquires the creation instruction to create the ICC profile (step S101; Yes), the creation controller determines whether the automatic creation processing is executable (step S104).

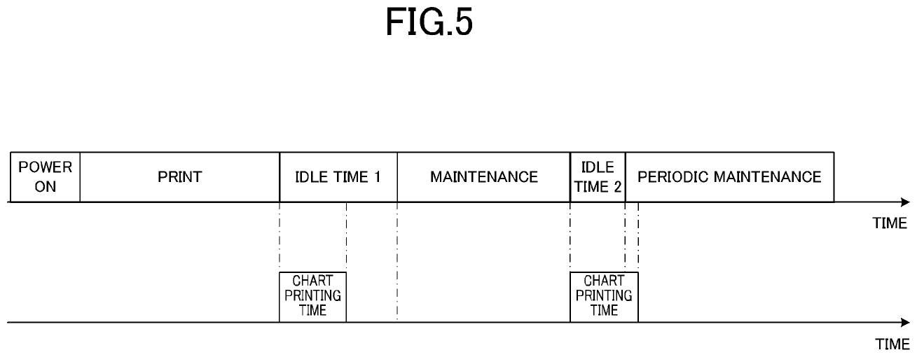

In the image forming apparatus 100, a process execution schedule as shown in a timeline chart of FIG. 5 is set based on a print job acquired by the acquisition section and on maintenance settings stored in advance in the storage section 13. In the process execution schedule, when the current time is an idle time during which neither the print job nor the maintenance processing is executed, the creation controller compares the length of the idle time with a time required for the automatic creation process. If the length of the idle time is longer than the time required for the automatic creation process, it is determined that the automatic creation process is executable. For example, in the example of FIG. 5, it is determined that the automatic creation process is executable during “idle time 1”, whereas it is determined that the automatic creation process is not executable during “idle time 2”.

If the automatic creation process is not executable (step S104; No), the creation controller returns to step S104 and waits until the idle time during which the automatic creation process is executable becomes available. If the automatic creation process is executable (step S104; Yes), the creation controller executes the automatic creation process (step S105; creation step). More specifically, the creation controller causes the conveyance section 30 to convey, from the sheet feed tray 21, the recording medium 200 for which the ICC profile is to be created, and causes the image forming section 40 to form a color chart. Then, the creation controller causes the recording medium 200 to be conveyed to the colorimetry section 70 and causes the color measurement device 72 to perform the color measurement, thereby causing the ICC profile to be created.

After executing the automatic creation process, the creation controller changes settings of the management table 131 in the same manner as in step S103 (step S106). Then, the creation controller determines whether another automatic creation process that is subsequent in the execution order remains pending (step S107). If no other automatic creation process is pending (step S107; No), the creation controller ends the ICC profile setting process.

If another automatic creation process is pending (step S107; Yes), the creation controller determines whether the color measurement processing for a first chart in the preceding automatic creation process has been completed (step S108). This is because, if a subsequent automatic creation process is executed to form a second chart before the color measurement processing by the color measurement device 72 is completed, the color measurement processing cannot be performed.

In addition, when the image forming apparatus 100 includes the image forming section 40 that forms the image by the inkjet method, as described above, the color measurement processing by the color measurement device 72 is preferably performed after a predetermined color measurement waiting time has elapsed from when the recording medium 200 is discharged to the colorimetry section 70.

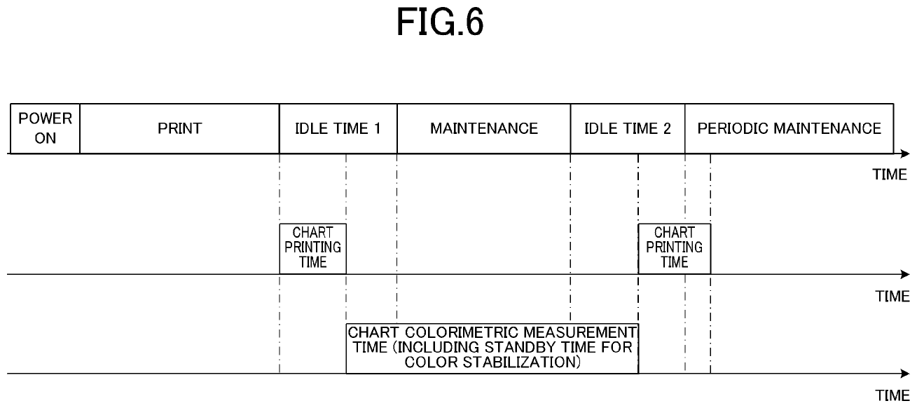

Therefore, when the image forming apparatus 100 forms the image by the inkjet method, as illustrated in FIG. 6, the creation controller determines whether the automatic creation process is executable by including, in the “color measurement process”, not only the chart printing time but also a standby time for stabilizing the ink color. In the example of FIG. 6, the length of “idle time 2” is longer than the “chart printing time”, but control is performed such that a subsequent automatic creation process is not performed during “idle time 2”.

If the color measurement processing by the color measurement device 72 in the preceding automatic creation process has not been completed (step S108; No), the creation controller returns to step S108 and waits. If the color measurement processing by the color measurement device 72 in the preceding automatic creation process has been completed (step S108; Yes), the creation controller determines whether the automatic creation process can be executed (step S109). If the automatic creation process is not executable (step S109; No), the process returns to step S109 and waits until the automatic creation process becomes executable. If the automatic creation process is executable (step S109; Yes), the creation controller proceeds to step S105 and executes the automatic creation process.

### Effects of the First Embodiment

As described above, the image forming apparatus 100 according to the present embodiment includes the sheet feed section 20 that accommodates the recording medium 200, the image forming section 40 that forms the image on the recording medium 200, and the color measurement device 72 that performs the color measurement on the image formed on the recording medium 200. In addition, the image forming apparatus 100 includes the controller 10 configured to function as the creation controller that executes the automatic creation process to automatically create the ICC profile corresponding to the recording medium 200 when the recording medium 200 for which the ICC profile is not set is present. According to the above-described configuration, because the image forming apparatus 100 includes the color measurement device 72 and executes the automatic creation process, the user does not need to manually perform the color measurement, and the ICC profile suitable for the recording medium 200 can be easily set.

Further, the controller 10 of the image forming apparatus 100 according to the present embodiment functions as the acquisition section that acquires the creation instruction for creating the ICC profile corresponding to the recording medium 200 accommodated in the sheet feed section 20. When the recording medium 200 for which the ICC profile is not set is present, and the acquisition section acquires the creation instruction, the creation controller executes the automatic creation process. According to the configuration, because the automatic creation process is executed only when the creation instruction to create the ICC profile is received, unnecessary operation of the image forming apparatus 100 can be suppressed when execution of the automatic creation process is unnecessary, for example, if the suitable ICC profile is stored in the storage section 13.

Further, the sheet feed section 20 of the image forming apparatus 100 according to the present embodiment accommodates the plurality of types of the recording medium 200. Then, the controller 10 functions as the acquisition section configured to acquire the execution order of the automatic creation processing for the plurality of types of recording medium 200. Then, the creation controller executes the automatic creation processing, based on the execution order, on the recording medium 200 for which the ICC profile is not set among the plurality of types of recording medium 200. According to this configuration, immediately after the plurality of types of new recording medium 200 are set, when image formation is to be performed using one recording medium 200 from the above, the setting can be made such that the ICC profile for such recording medium 200 is preferentially created, thereby suppressing delay in execution of the image forming process.

In addition, the image forming section 40 of the image forming apparatus 100 according to the present embodiment employs the inkjet recording method that forms the image by discharging the ink. Then, the color measurement device 72 starts the color measurement of the image after the predetermined time has elapsed since the image forming section 40 formed the image. With this configuration, the color of the image formed by the ink is stabilized, and the color measurement can be performed with higher accuracy.

When the color measurement of the first chart by the color measurement device 72 is not completed, the creation controller does not execute the automatic creation processing including creation of the second chart. According to this configuration, it is possible to suppress hindrance of the color measurement of the first chart by the color measurement device 72 caused by the recording medium 200 on which the second chart is formed.

### Second Embodiment

Next, the image forming apparatus 100 according to a second embodiment will be described. In the following description, components identical to those of the image forming apparatus 100 according to the first embodiment are denoted by the same reference numerals, and a detailed description thereof is omitted. The image forming apparatus 100 according to the second embodiment differs from the image forming apparatus 100 according to the first embodiment in that the acquisition section acquires the type of the recording medium 200 stored in the sheet feed section 20 and does not acquire the ICC profile creation instruction.

### ICC Profile Setting Process

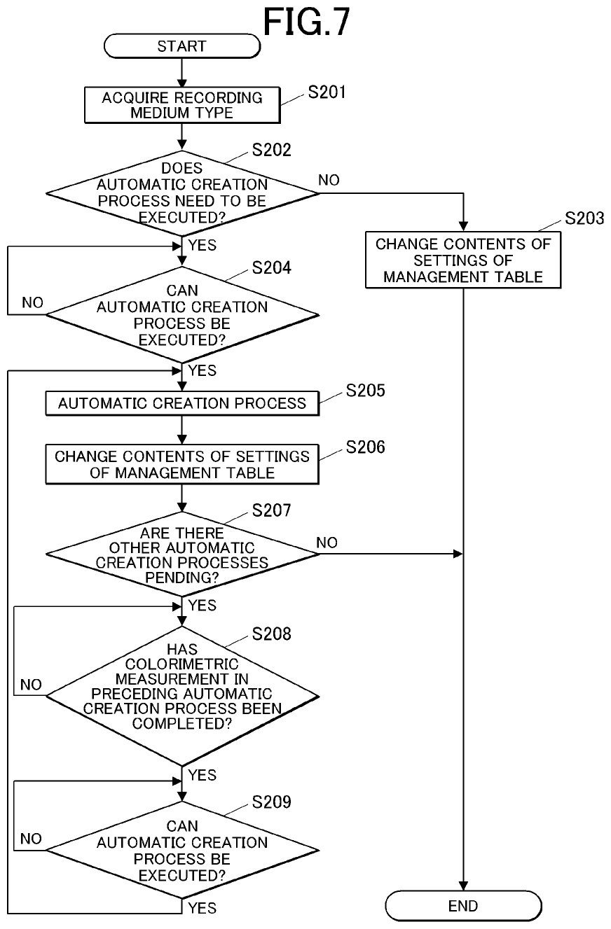

FIG. 7 shows the flowchart of the ICC profile setting process performed by the image forming apparatus 100 including such acquisition section. In the following description, steps S203 to S209 are substantially the same as steps S103 to S109 in the flowchart shown in FIG. 4, and thus the detailed description thereof will be omitted.

When the user sets the recording medium 200 in the predetermined sheet feed tray 21 of the sheet feed section 20, the controller 10 acquires the type of the recording medium 200 based on, for example, the data transmitted from the known sensor provided in the sheet feed tray 21 (step S201). Then, the controller 10 refers to the ICC profile DB 132 and determines whether execution of the automatic creation process is required (step S202).

When the ICC profile has been created in the past for the recording medium 200 and execution of the automatic creation process is unnecessary (step S202: No), the controller 10 proceeds to step S203. Then, the controller 10 updates, based on the content stored in the ICC profile DB 132, the record corresponding to the sheet feed tray 21 in the management table 131 (step S203). After the settings in the management table 131 are changed, the controller 10 ends the ICC profile setting process.

When the ICC profile has not been created in the past for the recording medium 200 and execution of the automatic creation process is necessary (step S202: Yes), the controller 10 proceeds to step S204 and performs the automatic creation process when the automatic creation process can be executed.

### Effects of the Second Embodiment

As described above, the image forming apparatus 100 according to the second embodiment includes the storage section 13 configured to store the ICC profile created by the creation controller, and the controller 10 functions as the acquisition section configured to acquire the type of the recording medium 200 accommodated in the sheet feed section 20. When there exists the recording medium 200 for which no ICC profile is set and the ICC profile corresponding to the recording medium 200 is not stored in the storage section 13, the controller 10 executes the automatic creation process. With this configuration, the user need not know whether the ICC profile suitable for the recording medium 200 is stored in the storage section 13, nor search the storage section 13 for the ICC profile suitable for the recording medium 200. Accordingly, the ICC profile suitable for the recording medium 200 can be set more easily.

In the above description, in step S202, whether to perform the automatic creation process is determined solely based on a determination by the controller 10 as to whether the automatic creation process is necessary; however, the present disclosure is not limited thereto. For example, a configuration may be employed in which the notification section 80 notifies the user of the result, determined by the controller 10, as to whether the automatic creation process is necessary, and the user makes a final determination.

### Other Configurations

Although a specific description has been given above based on the embodiments according to the present disclosure, the present disclosure is not limited to the above-described embodiments. It should be understood that various modifications may be made to the present disclosure within a scope equivalent to the scope of the invention recited in the appended claims.

For example, in the above description, the color measurement device 72 is configured to create the ICC profile; however, the present disclosure is not limited thereto, and the controller 10 that acquires the color measurement result of the color measurement device 72 may be configured to create the ICC profile.

In the above description, the ICC profile setting process is performed when a new recording medium 200 is used or when the image forming apparatus 100 is set up; however, the present disclosure is not limited thereto. The apparatus may be configured such that, when an elapsed time based on a difference between a set date and time stored in the management table 131 and a current date and time exceeds a set amount of time stored in advance in the storage section 13, the ICC profile setting process is executed again to reset the ICC profile. With the configuration in which such a resetting process is performed, even when the state of the recording medium 200 changes due to moisture or the like as a result of the recording medium 200 being accommodated in the sheet feed section 20 for a predetermined time, the ICC profile suitable for the recording medium 200 after the change can be set.

When such a reset process is performed, the existing ICC profile stored in the ICC profile DB 132 may be retained or overwritten (deleted) based on the setting, stored in the management table 131, indicating whether the ICC profile is required.

Further, in the above description, the idle time during which neither the print job nor the maintenance processing is executed is used as one condition for performing the automatic creation processing; however, the present disclosure is not limited thereto, and the automatic creation processing may be performed in the middle of the print job. For example, if the ICC profile corresponding to the recording medium 200 to be used in the subsequent print job is not set, creating the color chart and generating the ICC profile during the preceding print job can avoid delaying execution of the subsequent print job.

In the above description, an example in which an HDD is used as a computer-readable medium for a program according to the present disclosure has been disclosed; however, the present disclosure is not limited to this example. As another computer-readable medium, a portable recording medium such as a CD-ROM may be used. In addition, a carrier wave may also be used as a medium for providing program data according to the present disclosure via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming apparatus comprising:
a sheet feeder configured to accommodate a recording medium;
an image former configured to form an image on the recording medium;
a color measurer configured to measure a color of the image formed on the recording medium; and
a hardware processor configured to execute an automatic creation process for automatically creating an ICC profile corresponding to the recording medium for which the ICC profile is not set.

2. The image forming apparatus according to claim 1, wherein,
the hardware processor is configured to acquire a creation instruction to create the ICC profile corresponding to the recording medium accommodated in the sheet feeder, and
the hardware processor executes the automatic creation process when the recording medium for which the ICC profile is not set is present and the creation instruction is acquired.

3. The image forming apparatus according to claim 1,
further comprising, a storage configured to store the ICC profile created by the hardware processor,
wherein,
the hardware processor acquires a type of the recording medium accommodated in the sheet feeder, and
the hardware processor executes the automatic creation process when the recording medium for which the ICC profile is not set is present and the ICC profile corresponding to the type of the recording medium is not stored in the storage.

4. The image forming apparatus according to claim 1, wherein,
the sheet feeder accommodates a plurality of types of the recording medium, and
the hardware processor executes the automatic creation process for the recording medium, among the plurality of types of recording medium, for which the ICC profile is not set.

5. The image forming apparatus according to claim 4, wherein,
the hardware processor acquires an execution order of the automatic creation process for the plurality of types of recording medium, and
the hardware processor executes the automatic creation process based on the execution order.

6. The image forming apparatus according to claim 1,
further comprising a storage that stores a date and time at which the ICC profile is set for the recording medium,
wherein the hardware processor executes the automatic creation process and resets the ICC profile when an elapsed time from the set date and time is equal to or greater than a predetermined value.

7. The image forming apparatus according to claim 6, wherein,
the hardware processor is configured to acquire a creation instruction to create the ICC profile corresponding to the recording medium accommodated in the sheet feeder, and
the hardware processor executes the automatic creation process to reset the ICC profile when an elapsed time from the set date and time is equal to or greater than a predetermined value and the creation instruction is acquired.

8. The image forming apparatus according to claim 1,
further comprising a maintenance section configured to perform maintenance processing,
wherein the hardware processor executes the automatic creation process when the image former is not forming the image based on a print job and the maintenance section is not performing maintenance processing.

9. The image forming apparatus according to claim 1, wherein,
the image former forms the image by discharging ink, and
the color measurer starts color measurement of the image after a predetermined time has elapsed since the image former formed the image.

10. The image forming apparatus according to claim 9, wherein the hardware processor does not execute the automatic creation processing, which includes creating a second chart, when the color measurement of a first chart by the color measurer is incomplete.

11. The image forming apparatus according to claim 10, wherein the hardware processor causes the image former to form a chart while the image former is forming the image based on a print job.

12. The image forming apparatus according to claim 11, wherein, when executing a second print job for forming the image on a second recording medium subsequent to a first print job for forming the image on a first recording medium, and the ICC profile corresponding to the second recording medium is not set, the hardware processor causes the image former to form, during the first print job, the chart for setting the ICC profile corresponding to the second recording medium.

13. The image forming apparatus according to claim 10, wherein a color measurement tray configured to store the recording medium on which the chart used in the automatic creation processing is formed is provided separately from a discharge tray configured to store the recording medium on which the image based on the print job is formed.

14. An ICC profile creation method for creating an ICC profile by an image forming apparatus including, a sheet feeder configured to accommodate a recording medium; an image former configured to form an image on the recording medium; and a color measurer configured to measure a color of the image formed on the recording medium, the method comprising:
executing an automatic creation process for automatically creating the ICC profile corresponding to the recording medium for which the ICC profile is not set.

15. A non-transitory computer readable storage medium comprising a program executed in a computer of an image forming apparatus including, a sheet feeder configured to accommodate a recording medium; an image former configured to form an image on the recording medium; and a color measurer configured to measure a color of the image formed on the recording medium, the program causing the computer to perform,
executing an automatic creation process for automatically creating the ICC profile corresponding to the recording medium for which the ICC profile is not set.
